(19) United States
(12) Patent Application Publication
(10) Pub. No.: US 2013/0202155 A1
(43) Pub. Date: Aug. 8, 2013

(54) LOW-COST LANE MARKER DETECTION

(71) Applicant: Gopal Gudhur Karanam, Bangalore (IN)

(72) Inventor: Gopal Gudhur Karanam, Bangalore (IN)

(21) Appl. No.: 13/365,644

(22) Filed: Feb. 3, 2012

(51) Int. Cl. G06K 9/00

(52) U.S. Cl. 382/104

(57) ABSTRACT

A method for detecting a lane marker, the method including (i) receiving, from an image acquisition device, a first image comprising the road lane marker, (ii) scanning, into a memory, a first substantially horizontal line across the first image, (iii) computing, using a processor, an intensity gradient from the first scanned line, and (iv) determining a first position of the road lane marker by analyzing the intensity gradient.

### FIELD OF THE INVENTION

In various embodiments, the present invention relates, in general, to image processing and, more specifically, to detecting road-lane markers in images.

### BACKGROUND

Automated road-navigation systems provide various levels of assistance to automobile drivers to increase their safety and/or to reduce their driving effort. Various techniques have been developed to gather information about a vehicle's location, moving path, and/or surrounding environment. For example, vision-based road-lane tracking systems may be used to detect lane markers for adaptive cruise control, vehicle tracking, obstacle avoidance, lane-departure warning, and/or driving-pattern detection. In the lane-tracking systems, cameras may be mounted to the front of a vehicle to capture images of the roadway ahead of the vehicle, and image-processing software may be used to identify the lane markers in the images.

A Hough-transform algorithm may be used to identify lines in an acquired image, especially when the signal-to-noise ratio of the image is low and/or the variation of brightness in the image is large. The Hough transform converts a line in the image into a single point having two parameters: ρ (representing the shortest distance between the line and the origin) and θ (representing the angle between the shortest line and the x-axis). An image consisting of many shapes may therefore be converted into a plurality of (ρ,θ) pairs (which may be stored in a two-dimensional array of ρ and θ values), and analyzed to detect which shapes are lines. Because the Hough transform requires an unpredictable, random access to the two-dimensional array, however, it requires a large local memory or cache to hold the entire image and/or array in order to operate quickly and efficiently. If the Hough transform is run on a digital-signal, low-power, or other type of process having limited local memory, the entire image and/or array cannot be stored locally, resulting in an unacceptable number of calls to a much slower main memory. Additionally, the Hough Transform is able to detect only straight lane markers, not curved ones.

Other techniques, such as the so-called B-Snake road model and the probabilistic-fitting model, have been proposed to detect curved lane markers. They all, however, involve random memory accesses and thus require the entire image to be stored in the local memory to run efficiently and are similarly unsuitable for use with a processor having limited internal memory. Consequently, there is a need for real-time detection of both straight and curved lane markers using a low-cost, low-power processor having limited internal memory.

### SUMMARY

In various embodiments, the present invention relates to systems and methods for quickly and accurately detecting straight and/or curved road-lane markers using only a part of a received roadway image (or images), thereby providing real-time vehicle-position information, relative to the road-lane markers, without the need for a processor having a large internal/local memory. In one embodiment, a road-lane marker detector first scans through at least one horizontal line of the received image. The position of any road-lane markers in the received image is determined by computing and analyzing the intensity gradient of the scanned line; changes in the intensity gradient may indicate presence of one or more lane markers. The positions of two identified lane markers may further provide information about the vehicle's position relative to the lane markers. Furthermore, the shape of the roadway may be obtained by analyzing the lane markers' positions in multiple scanned lines of the image. Because the captured image is scanned line-by-line, only a small fraction of the image is needed during processing, and that fraction is predictable and deterministic (thus avoiding random access to memory). In one embodiment, images acquired at different times provide real-time information, such as the shape of the road and/or the distance between the vehicle and the lane markers. False detection of the lane markers may be reduced or eliminated based on properties of the lane-marker perspective geometry.

Accordingly, in one aspect, a method for detecting a lane marker includes: (i) receiving, from an image acquisition device, a first image including the lane marker; (ii) scanning, into a memory, a first substantially horizontal line across the first image; (iii) computing, using a processor, an intensity gradient of the first substantially horizontal line; and (iv) determining a first position of the lane marker by analyzing the intensity gradient. In one embodiment, analyzing the intensity gradient includes determining a left edge and a right edge of the lane marker in the first substantially horizontal line based at least in part on the intensity gradient. The substantially horizontal line may be a horizontal line. The method may further include determining a second position of a second lane marker by analyzing the intensity gradient and/or determining a position of a vehicle based on an angle between the first position of the road lane marker and the first substantially horizontal line.

The method may further include (i) scanning, into the memory, a plurality of additional substantially horizontal lines across the first image and (ii) determining positions of the lane marker in the plurality of additional substantially horizontal lines. A shape of a road may be determined based at least in part on the positions of the lane marker in the first substantially horizontal line and in the plurality of additional substantially horizontal lines.

A false detection of the lane marker may be eliminated in one of the substantially horizontal lines; eliminating the false detection of the lane marker may include (i) determining a width of the lane marker based at least in part on the intensity gradient and (ii) eliminating a false position of the lane marker having a width greater than a predetermined maximum threshold or less than a predetermined minimum threshold. Alternatively or in addition, eliminating the false detection of the lane marker may include (i) determining a vanishing point based at least in part on the positions of the lane markers in the plurality of scanned lines and (ii) eliminating a list of false positions having an associated line, wherein an extension of the associated line is outside of a detection region around the vanishing point.

The method for detecting a lane marker in a roadway may further include: (i) receiving, from an image acquisition device, a second image comprising the lane marker; (ii) scanning, into a memory, a second substantially horizontal line across the second image; (iii) computing, using a processor, a second intensity gradient from the second scanned line; and (iv) determining a second position of the lane marker by analyzing the second intensity gradient. A shape of a road may be determined based at least in part on the first position of the lane marker in the first image and the second position of the lane marker in the second image.

In another aspect, a system for detecting a lane marker in a roadway image includes: (i) an input port for receiving the roadway image; (ii) a main memory for storing the roadway image; (iii) a local memory for storing one substantially horizontal line of the roadway image; and (iv) a processor for computing an intensity gradient of the substantially horizontal line and determining a position of a lane marker in the substantially horizontal line. The processor, which may be a digital-signal processor, may be further configured for determining a position of a vehicle relative to the lane marker.

An output device may alert a user (via, for example, a user interface) if a distance between the vehicle and the lane marker is less than a threshold. An image-acquisition device may be used for acquiring the roadway image. The local memory of the system may be too small to store the roadway image; a link between the processor and the local memory in the system may be faster than a link between the processor and the main memory.

As used herein, the terms “approximately” or “substantially” means ±10% (e.g., by distance or by angle), and in some embodiments, ±5%. Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the following description, various embodiments of the present invention are described with reference to the following drawings, in which:

FIG. 1 is an illustration of an exemplary roadway scene;

FIG. 2 depicts a system for detecting lane markers in an image in accordance with an embodiment of the invention;

FIG. 3A depicts an intensity gradient map of a horizontal scanned line of a roadway image in accordance with an embodiment of the invention;

FIGS. 3B and 3C depict determining a vehicle's position based on the distance between the vehicle and the lane markers in accordance with an embodiment of the invention;

FIG. 4A illustrates central lines of straight lane markers in accordance with an embodiment of the invention;

FIG. 4B illustrates central lines of curved lane markers in accordance with an embodiment of the invention;

FIG. 4C depicts a segmented lane marker in accordance with an embodiment of the invention;

FIGS. 5A and 5B depicts determining a vehicle's position based on the angle between the central lines of the lane markers and the horizontal scanned line in accordance with an embodiment of the invention;

FIG. 6 depicts a small region around the vanishing point for eliminating false detection of the lane markers in accordance with an embodiment of the invention; and

FIG. 7 depicts a method for detecting lane markers in an image in accordance with an embodiment of the invention.

### DETAILED DESCRIPTION

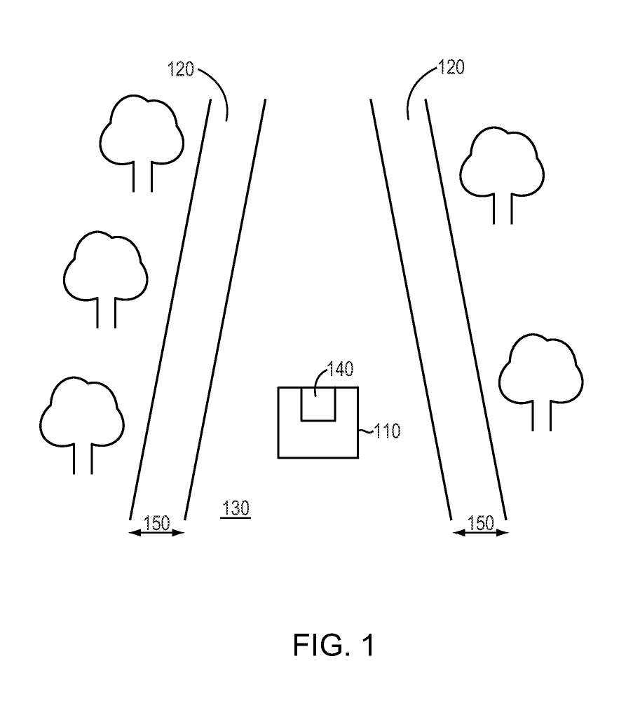

FIG. 1 illustrates a vehicle 110 on a roadway having lane markers 120 that define a lane 130. An image acquisition device 140, for example, a digital camera, is mounted on the vehicle 110 such that lane markers 120 are located in the viewing area of the image device 140. Each lane marker 120 has a width 150, which is typically standard and static in every country. Lane markers 120 may be continuous solid lines or include periodic segments (for example, ten-foot segments with 30-foot spaces in the U.S.).

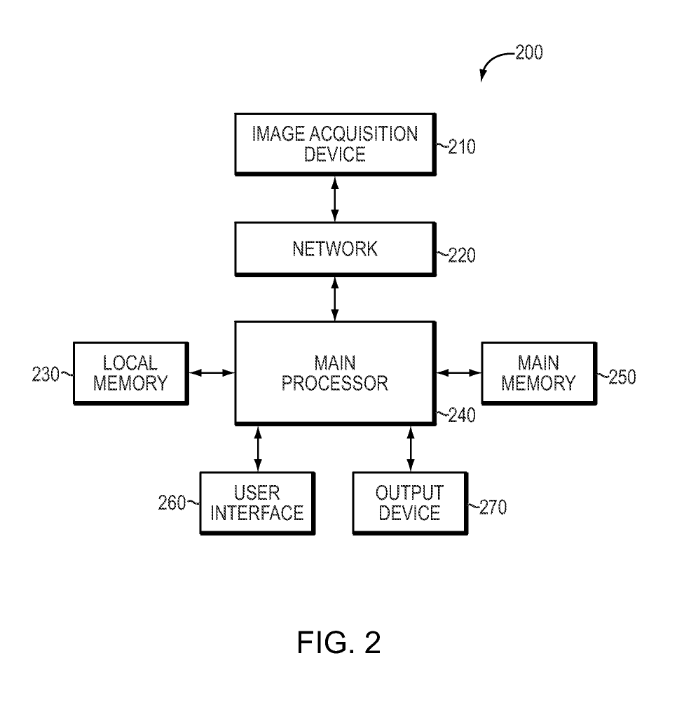

FIG. 2 illustrates one embodiment of a lane-marker detection system 200 for detecting lane markers in a roadway image. An image-acquisition device 210 passes a captured image, via a network link 220, to a processor 240; the image may be sent automatically by the device 210 (at, e.g., periodic intervals) or in response to a command from the processor 240. The network link 220 may be a bus connection, Ethernet, USB, or any other type of network link. The image-acquisition device 210 may be one or more still-image cameras, video cameras, or any other device or devices capable of capturing an image. The received image may be too large to store in its entirety in a local memory 230, and so the processor 240 may store the image in a main memory 250. As explained in greater detail below, the processor 240 fetches portions of the image from the main memory 250 and stores them in the local memory 230 to thereby determine positions of the lane markers using the fetched portions.

The system 200 may further include a user interface 260 (e.g., a WiFi link) for communicating with a user and/or an output device 270, such as an alarm. The local memory 230 may be disposed outside of the main processor 240 or located inside of the main processor 240. The main processor 240 may be implemented as part of a computer, a mobile device, a navigation system, or any other type of computing system. The user interface 260 may output and display results to a user and/or receive requests, such as commands and/or parameters from the user. The output device 270 may provide an audio or visual alert to the user when, for example, the vehicle drifts too close to the lane markers. In one embodiment, the processor 240 connects to the steering system of the vehicle. When the vehicle is too close to the lane markers, the steering system forcibly steers the vehicle back to the center of the road. If the automatic driving system is enabled, the steering system maintains the vehicle's position in the center of the road based on detected positions of the lane markers.

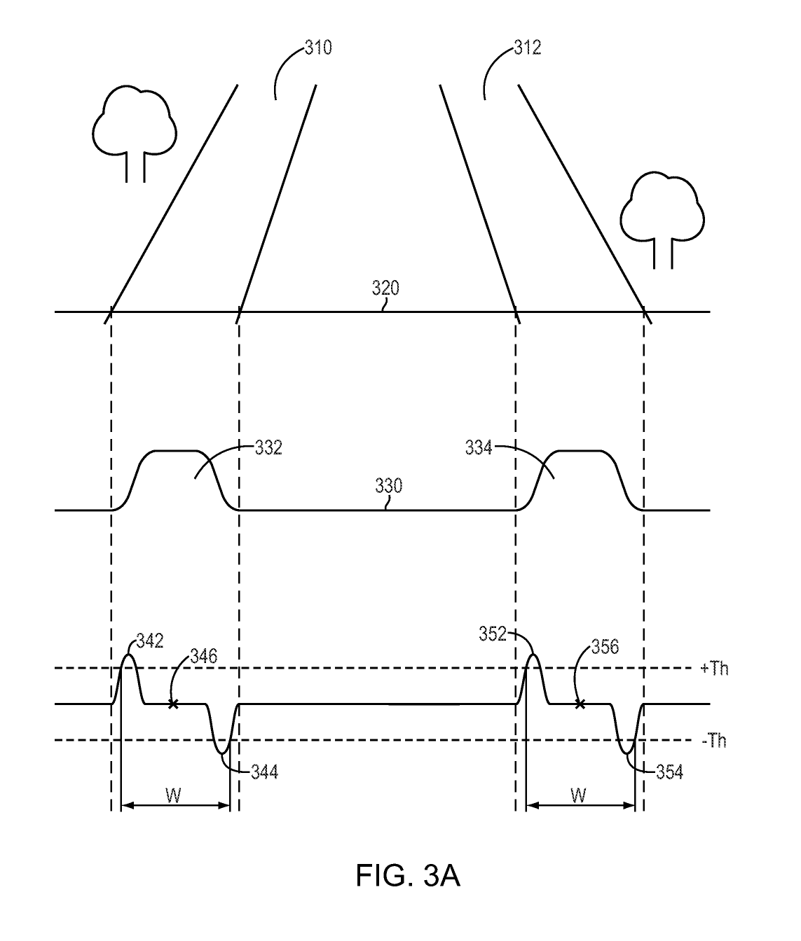

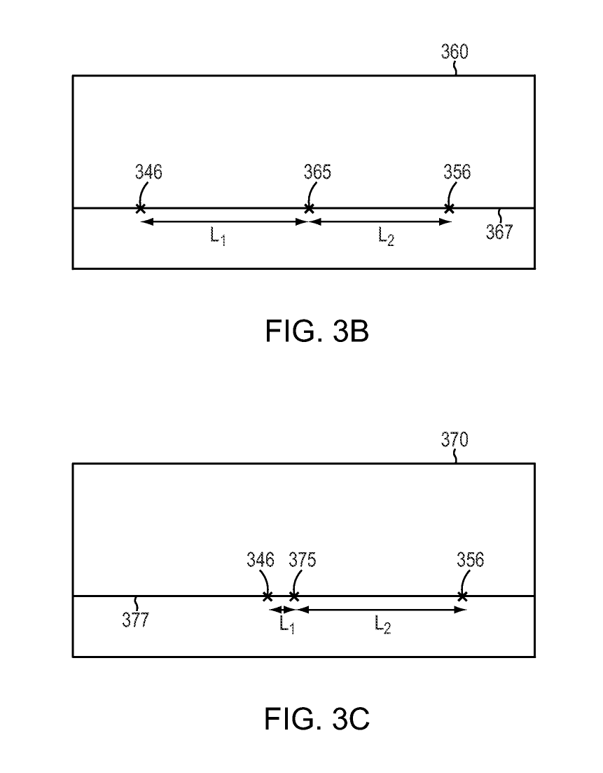

With reference to FIG. 3A, in various embodiments, upon receiving images including the lane markers 310, 312, a lane marker detector scans at least one line 320 substantially horizontally across the received image. As used herein, the term “substantially” means ±10, 5, 2, or 1 degrees by angle with the horizontal and/or ±5, 2, or 1 pixels difference in height across the image. An intensity map 330 containing the intensity value (i.e., pixel value) of each pixel in the scanned line 320 is measured. The intensity map 330 may have higher values at points 332, 334 corresponding to the locations in the horizontal line 320 where the lane markers 310, 312 occur. For example, the roadway surface may be darker-colored asphalt or concrete, and the lane markers 310, 312 may be lighter-colored yellow or white paint. The lighter colors of the lane markers 310, 312 produce greater values in the intensity map 330.

An intensity gradient 340 may be created using the intensity map 330. In some embodiments, a discrete differentiation filter that can be implemented efficiently in hardware or software is used to compute an approximation of the image intensity gradient. For example, a modified Prewitt Filter:

$$κ = [ \begin{matrix}- 1 & - 1 & - 1 & 0 & 0 & 0 & 1 & 1 & 1 \\ - 1 & - 1 & - 1 & 0 & 0 & 0 & 1 & 1 & 1 \\ - 1 & - 1 & - 1 & 0 & 0 & 0 & 1 & 1 & 1\end{matrix} ] ,$$

may be used to obtain the intensity gradient map 340. The left edge of the lane marker 310 may be found by identifying a point at which the left side 342 of the intensity gradient 340 increases above a predetermined maximum threshold, +Th; the right edge of the lane marker 310 may be found by identifying a point at which the right side 344 of the intensity gradient 340 increases above a predetermined minimum threshold, −Th.

Detecting the lane markers based on the intensity gradient 340 may be performed under various lighting conditions, such as bright sun light or dim moon light. In various embodiments, +Th and −Th are adjusted to reflect the quality of the image contrast and/or brightness of the image. For example, +Th and −Th may have low absolute values when an image has poor contrast and high absolute values when the image has good contrast. The center 346 and the width w of the lane marker 310 may be determined based on the left 342 and right 344 edges thereof. Detecting positions of the lane markers is thereby very fast, occurring as soon as one horizontal line is scanned and the intensity gradient map thereof is analyzed. Embodiments of the current invention, therefore, may be implemented in a low-cost processor having limited memory.

In one embodiment, the lane marker 312 on the other, right-hand side of the road is detected based on the intensity gradients 352, 354, using the same approach as described above. The position of the vehicle relative to the lane markers may then be estimated using the detected centers 346, 356 of the lane markers. With reference to FIG. 3B, the centers 346, 356 are the locations of the left 310 and right 312 lane markers, respectively, in an image 360. The distances between a reference point (for example, the center 365 of the scanned line 367) in the image 360 and the left 346 and right 356 centers of the lane markers 310, 312 are measured as L₁ and L₂, respectively. Assuming the camera is mounted in the middle of the vehicle, if L₁≈L₂, the vehicle is approximately in the middle of the lane. Whereas, if L₁<L₂ (as illustrated in FIG. 3C), the vehicle may be disposed closer to the left lane marker 310 than to the right lane marker 312. In one embodiment, an alarm or other device may be enabled to present an audio or visual alert to the driver when, for example, the vehicle drifts too close to one of the lane markers 310, 312. In another embodiment, if the vehicle is too close to the lane markers 310, 312, the steering system of the vehicle forcibly steers the vehicle back to the center of the road. In another embodiment, where the automatic driving system is on, the steering system adjusts the vehicle's position back to the center of the road upon detecting L₁≠L₂. In various embodiments, if the camera is not mounted in the middle of the vehicle, the position of the reference points 365, 375 are adjusted accordingly.

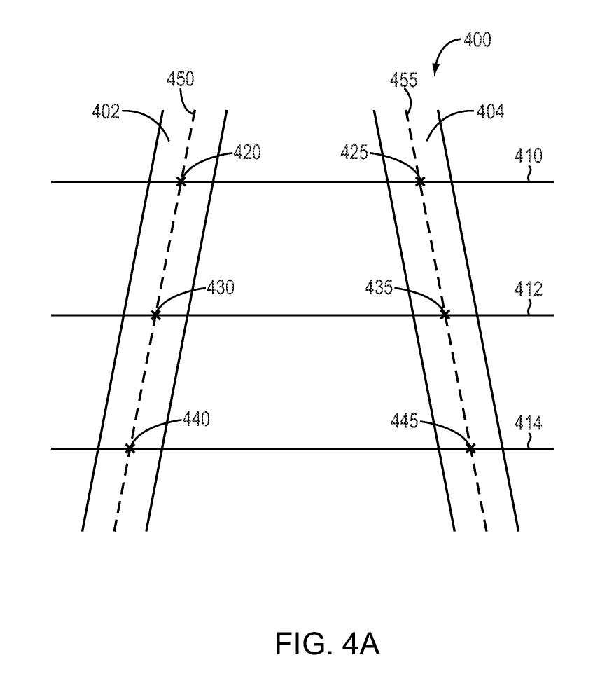

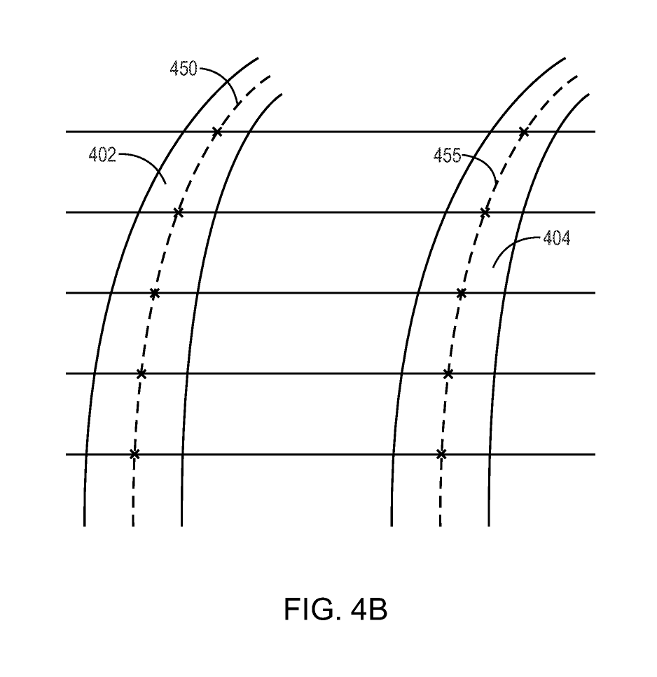

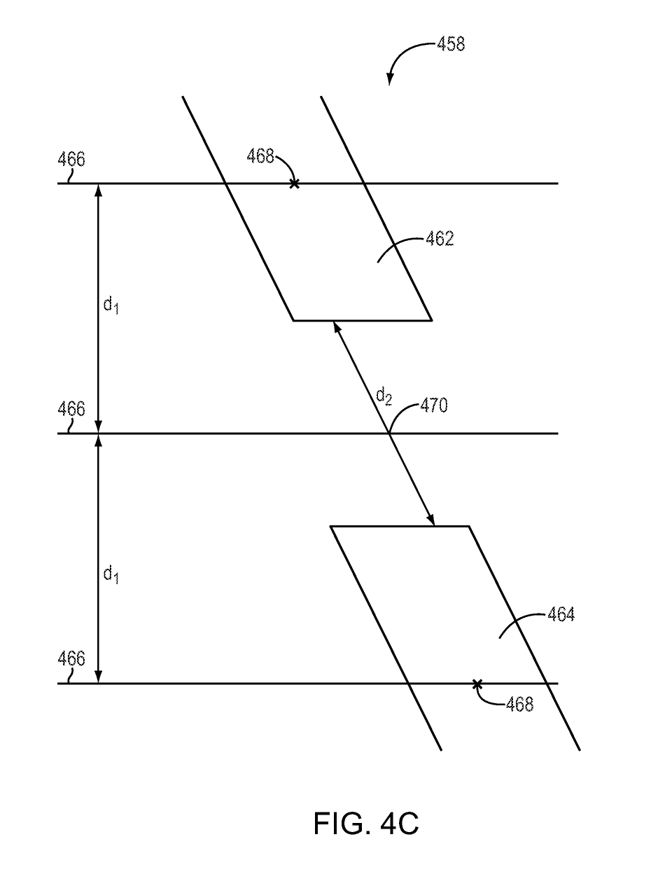

More than one line in an image may be scanned, and additional information about the image may be derived from the two or more lines. FIG. 4A depicts multiple horizontal scanned lines 410, 412, 414 in the received image 400. Centers of the left 402 and right 404 lane markers in each scanned line 410, 412, 414 are determined based on the intensity gradients thereof, as described above. For example, centers 430, 435 correspond to the left 402 and right 40 lane markers, respectively, of the scanned line 412. In one embodiment, detected positions (or centers) (e.g., 420, 430, 440) of the lane makers in multiple scanned lines are connected to form a line 450; this connected line 450 represents the central line of one lane marker (for example, the left lane marker 402 in FIG. 4A). The central line 450 of the lane marker 402 provides information about, for example, the shape of the roadway (e.g., a straight road in FIG. 4A or a curved road as in FIG. 4B) in accordance with the straightness or curvedness of the central line 450.

Some lane markers may be dashed (i.e., they may contain periodic breaks). In some embodiments, referring to FIG. 4C, the dashed lane markers 462, 464 are detected by scanning the received image 458 with a plurality of horizontal lines, as described above. The horizontal lines may be close enough to each other to ensure that at least one, two, or more of the horizontal lines intersect with the dashed lane marker and not only the breaks in-between. For example, a distance d₁ between the horizontal lines may be less than a distance d₂ between the dashes 462, 464. If a point 470 between detected line centers 468 is not detected, it may be assumed that the line centers 468 constitute a dashed line (and not, for example, noise in the image) if the distance between detected centers 468 is less than a threshold.

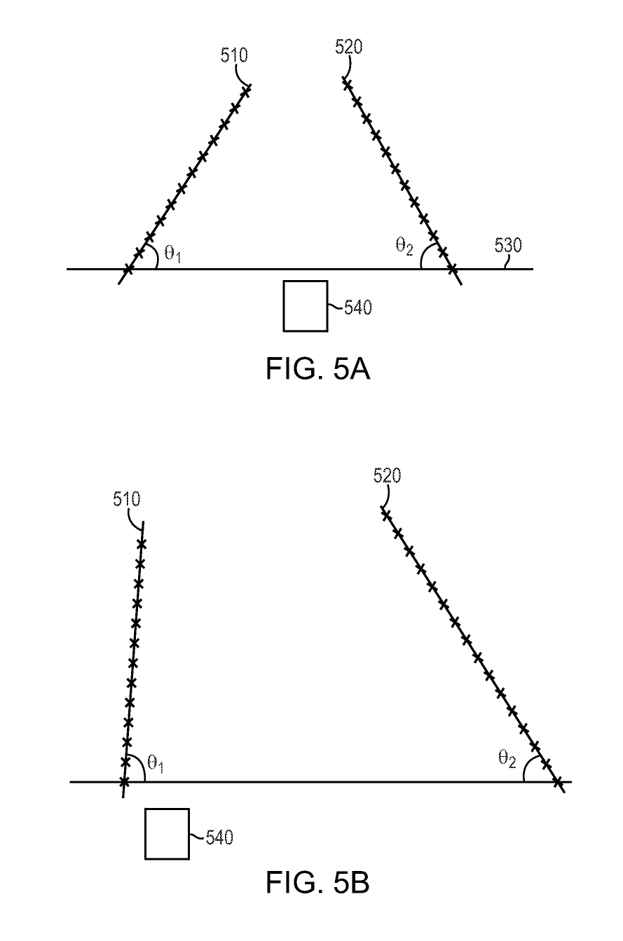

In various embodiments, a relative distance between the vehicle and the lane markers may be determined based on the angles between the detected central lines and the scanned horizontal lines. Referring to FIG. 5A, detected centers of the left and right lane markers are connected to form central lines 510, 520. Angles between the horizontal scanned line 530 and the connected central lines 510, 520 are defined as θ₁ and θ₂, respectively. If the vehicle 540 is driven in the middle of the road lane, θ₁≈θ₂. On the other hand, if θ₁>θ₂, the vehicle 540 may be closer to the left lane marker than to the right road lane marker (FIG. 5B). The closeness of the vehicle to the central line 510 may be measured by analyzing θ₁: the larger θ₁ is, the closer the vehicle is to the left lane marker. If θ₁ is approximately 90 degrees, it indicates that the vehicle is driven on the left lane marker. In one embodiment, upon receiving a signal that θ₁ or θ₂ is larger than a threshold, the system enables an alarm to warn the driver about the vehicle approaching one of the lane markers. This approach thus requires the detection of only one lane to determine the relative distance between the vehicle and the lane marker.

In various embodiments, false detection of the lane markers is determined based on their width. In one embodiment, an assumption of approximately constant width of the lane marker is used to eliminate the false detection of the lane markers. For example, a detected lane marker having a width more than (or less than) 10% of a predetermined width size is considered a false detection; the detected center is then omitted in the current scanned line. The central line of the lane markers thus connects the centers detected from the previous scanned line and the next scanned line. The standard width size may vary in different countries and may be adjusted accordingly.

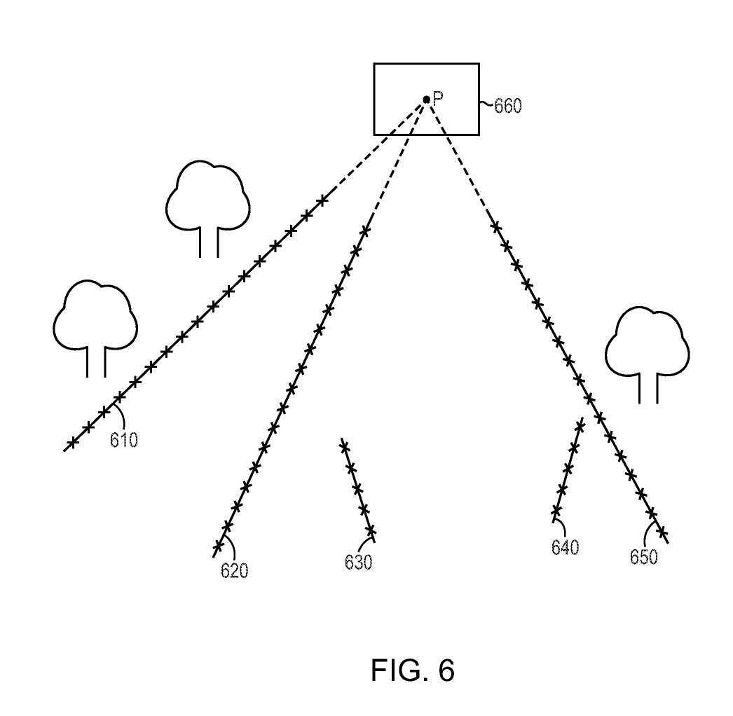

In another embodiment, an assumption that the left and right lane markers of a roadway vanish at a distant point is used to eliminate the false detection of the lane markers. This applies to both straight and curved lines. FIG. 6 depicts detected central lines 610, 620, 630, 640, 650 of the lane markers in an image. If the detected lines are actual lane markers, for example, lines 610, 620, 650, extrapolations of these central lines have a crossing point (or vanishing point), P, at a distance far ahead. The extrapolations may be fitted using the detected central points in a straight road or a curved road. If the detected central lines are false detections (e.g., lines 630, 640), extrapolations of the lines do not intersect with the vanishing point. In one embodiment, any detected central line that does not pass through a small region 660, for example, 5×5 pixels, around the vanishing point is considered as a false detection. Using the small region around the vanishing point together with the width criteria, therefore, provides an effective approach to quickly eliminate the false detection of the lane markers. In another embodiment, the central lines and/or the extrapolations thereof that do not intersect the “horizon” (i.e., the top part of the image, rather than a side of the image) are determined as a false detection.

In some embodiments, the lane marker detector receives a plurality of images taken at different points in time. The algorithms for lane marker detection and false detection elimination may be applied to each image and additional information may be extracted. For example, if it is detected that the vehicle is close to a lane marker but that the vehicle is moving back toward the center of the lane, a minor (or no) alarm may be sounded. If, on the other hand, the vehicle is close to the lane marker but is moving even closer to the lane marker, a louder or more noticeable alarm may be raised. Because the algorithms use only a fraction of each image to detect the lane markers therein, it is computationally fast to detect lane markers in this temporal series of images and thereby provides real-time information about, for example, the vehicle position relative to the lane markers and/or the shape of the roadway.

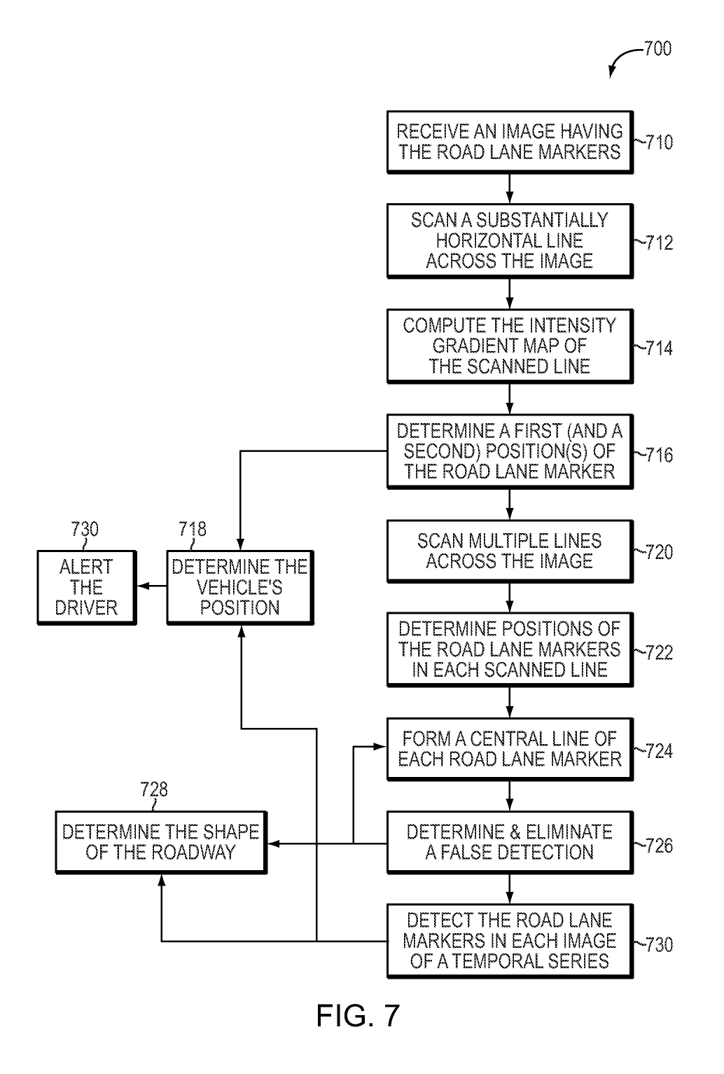

A method 700 for detecting lane markers in accordance with embodiments of the current invention is shown in FIG. 7. In a first step 710, an image containing the lane markers is received. In a second step 712, a substantially horizontal line is scanned across the image. In a third step 714, the intensity gradient map of the scanned line is computed. A position of the lane marker is then determined based on the intensity gradient of the scanned line and predetermined maximum and minimum thresholds of the intensity gradient (step 716). A second position of a second lane marker in the scanned line is also determined using the same algorithm in step 716. A relative position of the vehicle to the lane markers can then be determined based on the detected positions of the lane markers (step 718). In step 720, multiple substantially horizontal lines are scanned across the received image. Positions of the lane markers in each scanned line are determined based on the associated intensity gradients (step 722). The detected centers of each lane marker are connected to form a central line in step 724. A false detection is then determined and eliminated based on properties of the perspective geometry (for example, the width of the lane markers and/or a small region around the vanishing point) and the central lines are updated accordingly in step 726. Information, such as the relative position of the vehicle to the lane markers and/or the shape of the roadway is extracted in step 728. The lane marker detecting algorithm is applied to a temporal series of images in step 730 to obtain real-time information about the vehicle and the roadway. An audio alarm or visual display alerts the driver if the vehicle drifts too close to the lane markers (step 732).

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method for detecting a lane marker in a roadway, the method comprising:
receiving, from an image acquisition device, a first image comprising the lane marker;
scanning, into a memory, a first substantially horizontal line across the first image;
computing, using a processor, an intensity gradient of the first substantially horizontal line; and
determining a first position of the lane marker by analyzing the intensity gradient.

2. The method of claim 1, wherein analyzing the intensity gradient comprises determining a left edge and a right edge of the lane marker in the first substantially horizontal line based at least in part on the intensity gradient.

3. The method of claim 1, further comprising determining a second position of a second lane marker by analyzing the intensity gradient.

4. The method of claim 3, further comprising determining a position of a vehicle based on an angle between the first position of the road lane marker and the first substantially horizontal line.

5. The method of claim 3, further comprising
scanning, into the memory, a plurality of additional substantially horizontal lines across the first image; and
determining positions of the lane marker in the plurality of additional substantially horizontal lines.

6. The method of claim 5, further comprising determining a shape of a road based at least in part on the positions of the lane marker in the first substantially horizontal line and in the plurality of additional substantially horizontal lines.

7. The method of claim 5, further comprising eliminating a false detection of the lane marker in one of the substantially horizontal lines.

8. The method of claim 7, wherein eliminating the false detection of the lane marker comprises:
determining a width of the lane marker based at least in part on the intensity gradient; and
eliminating a false position of the lane marker having a width greater than a predetermined maximum threshold or less than a predetermined minimum threshold.

9. The method of claim 7, wherein eliminating the false detection of the lane marker comprises:
determining a vanishing point based at least in part on the positions of the lane markers in the plurality of scanned lines; and
eliminating a list of false positions having an associated line, wherein an extension of the associated line is outside of a detection region around the vanishing point.

10. The method of claim 1, further comprising:
receiving, from an image acquisition device, a second image comprising the lane marker;
scanning, into a memory, a second substantially horizontal line across the second image;
computing, using a processor, a second intensity gradient from the second scanned line; and
determining a second position of the lane marker by analyzing the second intensity gradient.

11. The method of claim 10, further comprising determining a shape of a road based at least in part on the first position of the lane marker in the first image and the second position of the lane marker in the second image.

12. The method of claim 1, wherein the substantially horizontal line is a horizontal line.

13. A system for detecting a lane marker in a roadway image, the system comprising:
an input port for receiving the roadway image;
a main memory for storing the roadway image;
a local memory for storing one substantially horizontal line of the roadway image;
a processor for:
i. computing an intensity gradient of the substantially horizontal line; and
ii. determining a position of a lane marker in the substantially horizontal line.

14. The system of claim 13, wherein the processor is further configured for determining a position of a vehicle relative to the lane marker.

15. The system of claim 14, further comprising an output device for alerting a user if a distance between the vehicle and the lane marker is less than a threshold.

16. The system of claim 13, further comprising a user interface for communicating with the processor.

17. The system of claim 13, further comprising an image-acquisition device for acquiring the roadway image.

18. The system of claim 13, wherein the processor is a digital-signal processor.

19. The system of claim 13, wherein the local memory is too small to store the roadway image.

20. The system of claim 13, wherein a link between the processor and the local memory is faster than a link between the processor and the main memory.
